(19) United States
(12) Patent Application Publication
(10) Pub. No.: US 2007/0108981 A1
(43) Pub. Date: May 17, 2007

(54) METHOD AND SYSTEM FOR DETERMINING AN ELECTROMAGNETIC RESPONSE FROM AN EARTH FORMATION AND METHOD OF DRILLING A BOREHOLE

(76) Inventors: Erik Jan BANNING-GEERTSMA, Houston, TX (US); Teruhiko HAGIWARA, Houston, TX (US); Richard Martin OSTERMEIER, Houston, TX (US)

Correspondence Address: SHELL OIL COMPANY, P O BOX 2463, HOUSTON, TX, 772522463, US

(21) Appl. No.: 11/461,696

(22) Filed: Aug. 1, 2006

Related U.S. Application Data
(60) Provisional application No. 60/705,011, filed on Aug. 3, 2005.

(51) Int. Cl. G01V 3/00

(52) U.S. Cl. 324/338

(57) ABSTRACT

An electromagnetic response from a region in an earth formation is determined by lowering an electromagnetic measurement tool into a borehole in the earth formation. The tool comprises a transmitter antenna, a receiver antenna, and an electrically conductive support structure. The transmitter antenna is energized, resulting in receiver signal in the receiver antenna. A raw response signal, comprising the receiver signal, is measured at the receiver antenna. The raw response signal is adjusted using a reference signal obtained by measuring the response signal of the tool in a test environment having a resistivity that is higher than that of the region in the earth formation. This method can be employed during the drilling of the borehole which may be part of a method of producing a mineral hydrocarbon fluid.

### CROSS REFERENCE TO RELATED APPLICATION

This application claims benefit of priority from U.S. Provisional application No. 60/705,011 filed 3 Aug. 2005.

### FIELD OF THE INVENTION

The invention relates to a method and system for determining an electromagnetic response from a region in an earth formation. In another aspect, the invention relates to a method of drilling a borehole in an earth formation. In still other aspects the invention relates to a method of producing a mineral hydrocarbon fluid from an earth formation.

### BACKGROUND OF THE INVENTION

Tools for electromagnetic investigation of the earth formation may often comprise a conductive object in the vicinity of the antennae. For instance a conductive support structure may be present as part of the tool in the form of a mandrel or a housing.

Electromagnetic induction well logging instruments, for instance, might typically be adapted to be lowered into a wellbore and removed therefrom by means of an armored electrical cable coupled to the instrument housing.

Measuring while drilling (MWD) logging instruments, which may also include various forms of electromagnetic induction logging instruments, may comprise a steel or other high strength metallic housing so that the instrument can also properly perform the function of a part of the drill string. As a result, the typical MWD well logging instruments nearly always have an electrically conductive support structure.

Still further, it is also known in the art to include high strength, electrically conductive support rods inside wireline electromagnetic induction well logging instruments in order to enable such instruments to support the weight of additional well logging instruments coupled below the induction logging instrument. See, for example, U.S. Pat. No. 4,651,101 issued to Barber et al.

Because of the likelihood of the presence of a conductive support structure within an electromagnetic induction logging apparatus as explained above, it is desirable to have a method to adjust the response of such instruments for the effect of the conductive support structure.

It is proposed in U.S. Pat. No. 6,891,376 to Hanstein et al to measure electromagnetic induction response in an earth formation surrounding a wellbore using an actual system having a sonde on an electrically conductive support and deconvolve the measured response with respect to a response of a test system not having the electrically conductive sonde support. The sonde support is a conductive housing.

To this end, it is explained in said U.S. Pat. No. 6,891,376, the response of the test system is characterised. Then a convolution operator is determined that causes the response of the test system to match the response of the actual system. Having thus determined the convolution operator, a deconvolution operator is based thereon so that measured response of the actual system to a formation surrounding the wellbore can be deconvolved to approximate the response of the test system—having no conductive housing—would have had in the same formation. This way, it is stated, measurements of the actual system can be processed using the deconvolution operator determined as explained above to generate measurements of electromagnetic induction properties of the earth formation in which the effects of the conductive housing or sonde support have been reduced or even eliminated.

The method of U.S. Pat. No. 6,891,376 requires that for each actual system a test system is prepared for finding the appropriate convolution operator.

Moreover, the convolution operator as determined in the way as set out in U.S. Pat. No. 6,891,376 might not be applicable with the same level of accuracy in types of formation that are different from the formation wherein the convolution operator has been determined using the test system.

### SUMMARY OF THE INVENTION

According to a first aspect of the invention there is provided a method of determining an electromagnetic response from a region in an earth formation, comprising:

lowering an electromagnetic measurement tool comprising a transmitter antenna, a receiver antenna, and an electrically conductive support structure, into a borehole in the earth formation;

energizing the transmitter antenna resulting in a receiver signal in the receiver antenna;

measuring a raw response signal comprising the receiver signal;

adjusting the raw response signal using a reference signal obtained by measuring the response signal of the tool in a test environment having a resistivity that is higher than that of the region in the earth formation.

According to a second aspect, the invention provides a system for determining an electromagnetic response from a region in an earth formation, comprising:

a electromagnetic measurement tool that is lowerable in a borehole in the earth formation, the electromagnetic measurement tool comprising a transmitter for transmitting a signal, a receiver for receiving a receiver signal, and an electrically conductive support structure;

a data acquisition unit coupled to at least the receiver to collect a raw response signal comprising the receiver signal from the receiver;

a computing system coupled to the acquisition system to receive the raw response signal and programmed to adjust the raw response signal using a reference signal obtained by measuring the response signal of the tool in a test environment having a resistivity that is higher than that of the region in the earth formation.

The computing system may comprise or be coupled to a memory unit wherein the reference system is stored.

The method outlined above may be used as part of a method of drilling a borehole in an earth formation, wherein a borehole is drilled using a drill string. At least a part of the drilling comprises:

lowering the drill string into the borehole that is being drilled, the drill string comprising the electromagnetic measurement tool.

The adjusted signal may be utilized to determine an electromagnetic induction property of the earth formation. During continued drilling of the hole, the drill string may be steered in response to the thus determined electromagnetic property of the earth formation.

In still another aspect, the invention provides a method of producing a mineral hydrocarbon fluid from an earth formation, comprising:

drilling a borehole in the earth formation in accordance with the method as outlined above, until a reservoir is reached that contains the mineral hydrocarbon fluid; and

producing the hydrocarbon fluid from the reservoir.

These and other embodiments of the invention will be elucidated below by way of example and with reference to the accompanying drawing.

### BRIEF DESCRIPTION OF THE DRAWING

In the accompanying drawing:

FIG. 1A is a block diagram showing a system implementing embodiments of the invention;

FIG. 1B schematically illustrates an alternative system implementing embodiments of the invention;

FIG. 2 shows a plot with computationally simulated transient signals that can be measured by coaxial coils (radius 125.0 mm) wrapped around a metal cylinder (radius 123.2 mm) embedded in air and in a whole-space having a conductivity of 1 S/m;

FIG. 3 shows a plot with computed transient signals that can be measured by coaxial coils wrapped around a metal cylinder embedded in a whole-space having a conductivity of 10 S/m, a deconvolved signal, and a signal of an analytical dipole in the whole-space;

FIG. 4 shows a plot of a deconvolution scaling factor A as a function of tool spacing L;

FIG. 5 shows curves of computed raw transient response signal of the tool with mandrel in an earth formation having a conductivity of 1 S/m, of reference response of tool with mandrel in air, a deconvolved signal, and an analytical point dipole whole-space response for reference;

FIG. 6 shows a plot of computed adjusted response signals in various earth formations having conductivities ranging from 0.01 to 100 S/m after deconvolution using a reference signal obtained in a test environment of 1 S/m, and corresponding analytical point dipole whole-space responses;

FIG. 7 shows a plot of computed raw and deconvolved transient response signals, and a corresponding analytical point dipole whole-space response for a tool having a resistive mandrel with a conductivity of 10 S/m;

FIG. 8 schematically shows a electromagnetic measurement tool in a bore hole adjacent to a bed boundary;

FIG. 9 shows a plot of simulated signals that would be measurable with the tool of FIG. 8 as it is moved from one bed to the other;

FIG. 10 shows the same curves as in FIG. 9 but now adjusted by subtraction of a reference signal determined in air as the test environment;

FIG. 11 shows curves from FIG. 9 adjusted by deconvolving using a reference signal determined in air as the test environment;

FIG. 12 shows a reference plot with simulated transient signals that would be measurable with the tool of FIG. 8 as it is moved from one bed to the other, for a tool without a conductive support structure;

FIG. 13 shows a plot of simulated raw and deconvolved response signals, and a corresponding analytical point dipole whole-space response for an off-axis anntennae tool;

FIG. 14 shows a plot of simulated raw and deconvolved response signals, and a corresponding analytical point dipole whole-space response for another off-axis anntennae tool;

FIG. 15 shows a plot of simulated signals that can be obtained from a tool having coaxial coils wrapped around a high-μ coated conductive support structure;

FIG. 16 shows for two earth formations, having respective conductivities of 1 S/m and 10 S/m, plots containing calculated raw response signal curves, adjusted response signal curves by subtraction of an air-determined reference signal, and analytical point dipole solutions;

FIG. 17 shows, for two earth formations, adjusted simulated response signal curves by subtraction of an air-determined reference signal, measurable using a tool with magnetic shielding layer, and analytical point dipole solutions; and

FIG. 18 shows, for two earth formations, deconvolved simulated response signal curves as measurable using a tool with magnetic shielding layer, and analytical point dipole solutions.

In the Figures, like parts carry identical reference numerals. Whenever the word “measured” is mentioned in conjunction with the Figures, the shown data was simulated and calculated.

### DETAILED DESCRIPTION OF EMBODIMENTS

In U.S. Pat. No. 5,955,884 to Payton et al a tool and method are disclosed for transient electromagnetic logging, wherein electric and electromagnetic transmitters are utilized to apply electromagnetic energy to a formation at selected frequencies and waveforms that maximize radial depth of penetration into the target formation. In this transient EM method, the current applied at a transmitter antenna is generally terminated and temporal change of voltage induced in a receiver antenna is monitored over time.

In addition, the U.S. patent applications published under Nos. 2005/0092487 and 2005/0093546, both herewith incorporated by reference, describe transient electromagnetic (EM) methods for locating an anomaly in a subterranean earth formation, and in particular for finding the direction and distance to a resistive or conductive anomaly in a formation surrounding a borehole, or ahead of the borehole, in drilling applications.

These techniques have allowed or are expected to allow detection of an anomaly at distances removed as far as ten to one hundred meters away from the transmitter and/or receiver antennae.

Generally, the induced voltage in such techniques contains information on the resistivity and its inverse equivalent conductivity, of the formation surrounding the antennae. However, when a conductive object other than the formation is in the vicinity of the antennae the transmitter turn off is thought to generate large transient eddy currents in the conductive object. These, in turn, may generate large electromagnetic forces in the receiver antenna that could swamp any information-bearing contribution to the signal that arises from the electromagnetic properties of the formation.

As set forth above, embodiments of the invention comprise adjusting a raw response signal from a tool comprising a transmitter antenna, a receiver antenna, and an electrically conductive support structure, using a reference signal obtained by measuring a response signal of the tool in a test environment having a resistivity that is higher than that of the region in the earth formation from which an electromagnetic response is to be determined.

Since the reference signal is obtained in an environment wherein the resistivity is relatively high as compared to the region of interest in the earth formation, it carries a relatively high contribution from the conductive support structure. The reference signal can thus be utilized to adjust the raw response signal in order to remove from the raw response signal at least some of the contribution arising from the presence of the conductive support structure.

The adjusted response signal is thus a better approximation of the contribution to the signal of the electromagnetic response from the region in the earth formation without or at least with reduced contribution of response from the conductive support structure. This in effect results in a higher sensitivity of the electromagnetic induction tool to formation features.

An electromagnetic property of the region in the earth formation may be determined from the adjusted signal. In embodiments, this may be done in the same way as explained in for instance U.S. patent application 2005/0092487 and 2005/0093546.

For the purpose of interpreting this disclosure, the electromagnetic property to be determined may include at least a conductivity of the region in the earth formation and/or a spatial distribution of the conductivity through the earth formation. Instead of the term conductivity, the term resistivity may be used, which is the inverse equivalent of conductivity. Thus, the term conductivity is intended to cover both conductivity and resistivity.

In the context of the present specification, the term raw response signal is used to refer to the response signal before adjustment using the reference signal. This should not be interpreted as excluding the possibility of subjecting the response signal as measured to one or more other operations such as noise suppression operations, pre-amplification operations, filtering operations, and/or transformation operations.

The reference signal may be determined before lowering the tool in the borehole in the earth formation and stored for later use to adjust the raw response signal. This allows adjusting the raw response signals immediately once they have become available, for instance on the surface via a telemetry system, or even downhole employing a downhole signal processor. Alternatively, the reference signal may be determined subsequent to determining the raw response signal in the earth formation.

The reference signal may also be determined with the tool lowered in the borehole whereby it is far away from the region of interest in the earth formation. This works in particular when the region of interest is a relatively conductive region such as for instance the case with a shale formation.

No separate test system is required in which the electrically conductive support is omitted. The tool used for determining the reference signal may be the same tool as the tool used to be lowered into the borehole in the earth formation. Alternatively it may be a tool of the same kind, for instance one that is equivalent or substantially equivalent. More specifically, it may comprise an equivalent electrically conductive support structure.

The raw response signal may be adjusted for instance in time domain or in frequency domain. It is also a possibility that the raw response signal and/or the reference signal be measured in time domain and transformed to frequency domain, or measured in frequency domain and transformed to time domain.

The same reference signal, once obtained and suitably stored, can be utilized to adjust raw response signals measured in respect of any earth formation having a resistivity that is lower than the value of the resistivity of the environment in which the reference signal was determined.

In an embodiment, the electrically conductive support structure may comprise a mandrel on which the antennae are mounted, and/or a housing, such as a cylindrical housing in the form of a pipe part that can be included in the drill string to form part of the drill string.

In an embodiment, the conductive support structure may be provided with a magnetic shield layer. Such a magnetic shield layer may be applied in the form of a magnetic shield coating. It may comprise a material that has a resistivity higher than that of the conductive support structure and/or a magnetic permeability that is higher than that of the conductive support structure.

One way to adjust the raw response signal using the reference signal is by subtracting the reference signal from the raw response signal. This way of adjusting is computationally straight forward.

It has been found that this way works particularly well in combination with said magnetic shield coating applied to the conductive support structure.

After subtracting the reference signal from the raw response signal, the contribution to the signal from the formation is revealed even more clearly when the result is plotted on a logarithmic plot.

A computationally less straight forward, but a possibly more accurate way to adjust the raw response signal is by deconvolving the reference signal from the raw response signal. This way has been found to be unexpectedly effective at reducing the conductive support structure's contribution in the raw response signal.

The raw response signal and/or the reference signal may be acquired in time domain and transformed to corresponding signals in frequency domain prior to deconvolving, or vice versa.

The way of adjusting the raw response signal by deconvolving can also be advantageously applied in combination with said magnetic shield coating applied to the conductive support structure.

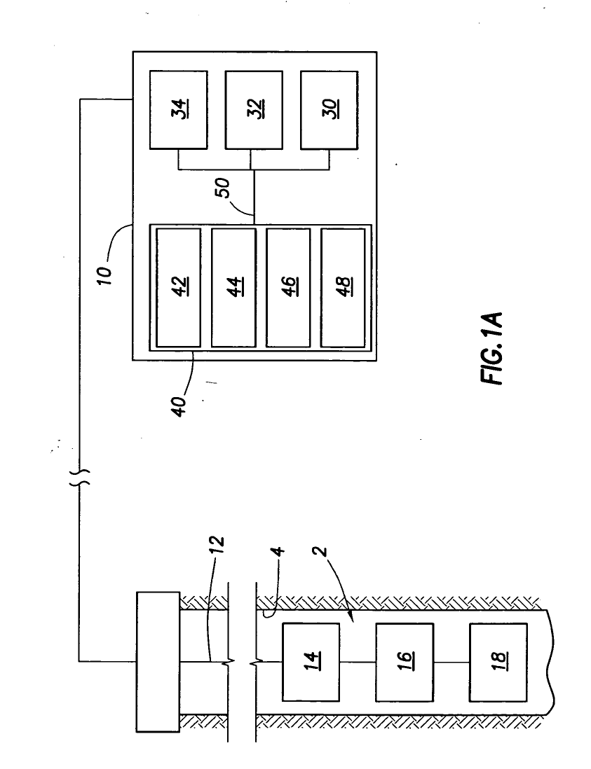

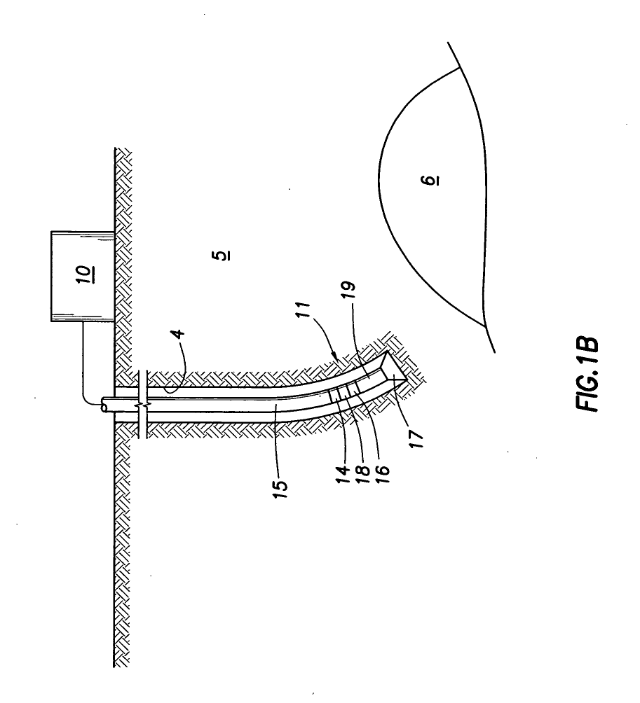

FIGS. 1A and 1B illustrate systems that may be used to implement the embodiments of the method of the invention. A surface computing unit 10 may be connected with an electromagnetic measurement tool 2 lowered in a borehole, such as wellbore 4. The tool 2 may be suspended in any suitable way. Suitable suspension means include a conductive cable, or a string of tubular elements such as a drill string.

In embodiments wherein a cable 12 is employed, such as illustrated in FIG. 1A, the cable 12 may be constructed of any known type of cable for transmitting electrical signals between the tool 2 and the surface computing unit 10. However, a cable 12 is not a prerequisite, as there are alternative means available for transmitting signals between the tool 2 and the surface computing unit 10, including mud-pulse systems or drill-pipe telemetry systems.

In FIG. 1B, the electromagnetic tool is incorporated in a measurement while drilling (MWD) string 11 and suspended in the wellbore 4 by a drill string 15. The drill string 15 further supports a drill bit 17, and may support a steering system 19. The steering system may be of a known type, including a rotatable steering system or a sliding steering system. The wellbore 4 traverses the earth formation 5 and it is an objective to precisely direct the drill bit 17 into a hydrocarbon fluid containing reservoir 6 to enable producing the hydrocarbon fluid via the wellbore 4. Such a reservoir 6 may manifest itself as an electromagnetic anomaly in the formation 5.

Referring now to both FIGS. 1A and 1B, one or more transmitters 16 and one or more receivers 18 may be provided for transmitting and receiving signals. The transmitters 16 may be located ahead of or behind the receivers 18 as seen from the dill bit 17. In various embodiments, a data acquisition unit 14 may be provided to transmit data to and from the transmitters 16 and receivers 18 to the surface computing unit 10.

Each transmitter 16 and/or receiver 18 may comprise a coil antenna, wound around a support structure such as a mandrel. The support structure may comprise a non-conductive section to suppress generation of eddy currents. The non-conductive section may comprise one or more slots, optionally filled with a non-conductive material, or it may be formed out of a non-conductive material such as a composite plastic.

Each transmitter 16 and each receiver 18 may be tri-axial and thereby contain components for sending and receiving signals along each of three axes. Accordingly, each transmitter module may contain at least one single or multi-axis antenna and may be a 3-orthogonal component transmitter. Each receiver may include at least one single or multi-axis electromagnetic receiving component and may be a 3-orthogonal component receiver.

The data acquisition unit 14 may include a controller for controlling the operation of the tool 2. The data acquisition unit 14 may collect signals from each transmitter 16 and receiver 18 and provides signals and/or data representative thereof to the surface computing unit 10.

The surface computing unit 10 may include computer components including a processing unit 30, an operator interface 32, and a tool interface 34. The processing unit 30 is programmed to receive the raw response signal as input and adjust the raw response signal using a reference signal obtained by measuring the response signal of the tool in a test environment having a resistivity that is higher than that of the region in the earth formation.

The surface computing unit 10 may also include a memory 40 including a 42 for storing information including the reference signal, and optionally also relevant coordinate system transformation data and assumptions, an optional direction calculation module 44, an optional apparent direction calculation module 46, and an optional distance calculation module 48. The optional direction and apparent direction calculation modules, and their operation, are described in more detail in U.S. patent application published under No. 2005/0092487 already incorporated by reference.

The surface computing unit 10 may further include a bus 50 that couples various system components including the system memory 40 to the processing unit 30. The computing system environment 10 is only one example of a suitable computing environment and is not intended to suggest any limitation as to the scope of use or functionality of the invention. Furthermore, although the computing system 10 is described as a computing unit located on a surface, it may optionally be located below the surface, incorporated in the tool, positioned at a remote location, or positioned at any other convenient location.

For further details on the computing system 10, including storage media and input/output devices, reference is made to U.S. patent application publication No. US 2005/0092487 which is herewith incorporated by reference. Accordingly, additional details concerning the internal construction of the computer 10 need not be disclosed in connection with the present invention.

For the purpose of simplifying the explanation below, a conductive support structure will be assumed to comprise of a conductive mandrel supporting the receiver and transmitter antennae, such as may be the case in a MWD system. However, this should not be interpreted as a limiting feature of the invention as the analysis is relevant for any form of conductive material or support structure present in the vicinity of the receiver-transmitter antennae couple.

The raw response signal, for instance comprising an induction voltage over the receiver antenna, carries contributions from both the mandrel as well as the earth formation surrounding the tool.

In the remainder of the specification, unless otherwise specified, the transmitter and receiver coils are arranged co-axially with respect to one another. The conductivity of the metal cylinder that forms the conductive support structure is 1×10⁷ S/m unless otherwise specified.

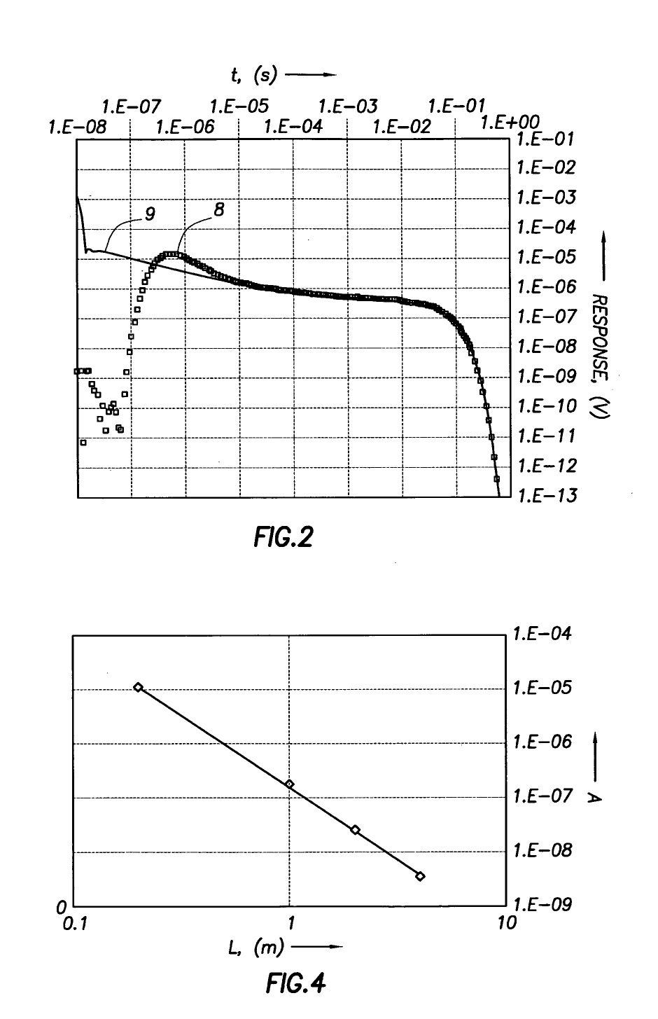

FIG. 2 shows an example of a plot of computationally simulated signals that can be measured using coaxially arranged transmitter and receiver coils wrapped around a conductive support structure in the form of a metal cylinder. The coils are presumed to be wound in a circular fashion with a diameter of Dcoil=250.0 mm around the metal cylinder that has a diameter of Dmandrel=246.4 mm. The axial separation L between the transmitter and receiver coils is 2 m. These parameters can be found in Table 1.

TABLE 1
legend to FIG. 2

| | | D | | Conductivity |
|---|---|---|---|---|
| | D coils | mandrel | | whole-space |
| line | (mm) | (mm) | L (m) | (S/m) |
| 8 | 250.0 | 246.4 | 2 | 1 |
| 9 | 250.0 | 246.4 | 2 | 10⁻⁵ |

The plot of FIG. 2 shows computed simulations of the transient potential over the receiver coil as a function of time t after suddenly shutting off the passing of current through the transmitter coil. Generally, the potential reflects the time derivative of the magnetic induction B, whereby B relates to the magnetization H via a factor μ which is the magnetic permeability of the region in the earth formation. Generally for earth formations and steel, it can be assumed that μ=μ₀ wherein μ₀ is the permeability of vacuum.

In the plot of FIG. 2, the dotted curve 8 shows the transient signal that would be obtainable with the described electromagnetic measurement tool surrounded by an earth formation in the form of a homogenous whole-space having a conductivity of 1 S/m, whereas the continuous curve 9 corresponds to the transient signal obtained with the tool suspended in air having typically a conductivity of 1×10⁻⁵ S/m.

It can be seen that in particular for longer times whereby t>1×10⁻⁵ s the raw signal curve 8 is determined to a large extent by the contribution arising from the mandrel.

In order to obtain a transient response signal that is indicative of the contribution arising from the transient behaviour of the earth formation only, the raw response signal 8 could thus be adjusted using the curve 9 as a reference signal that is indicative of the mandrel contribution. Such a reference signal can be obtained by measuring the response signal of the tool in a test environment having a resistivity that is higher than that of the region in the earth formation. A possible such environment would be formed by air as it has near-zero conductivity.

This way, the relative weight of the mandrel increases so that the reference signal is relatively indicative of what the mandrel contribution in the raw signal might have been.

Deconvolution

One group of embodiments of the invention makes use of an unexpected insight that the raw response signal in the receiver antenna, comprising an induction voltage as measured with the tool in a formation, that results from energizing the transmitter antenna, can be approximated by a convolution of the response of the system embedded in a whole-space having substantially zero conductivity with the response of a transmitter-receiver system without a conductive mandrel in the formation:

$$\frac{ⅆ B}{ⅆ t} {\vert}_{mandrel + formation} ≅ \frac{ⅆ B}{ⅆ t} {\vert}_{mandrel + air} ° \frac{ⅆ B}{ⅆ t} {\vert}_{formation} \qquad ( 1 )$$

In one embodiment of the invention, the contribution in the raw signal arising from the mandrel can be reduced or removed by deconvolving the raw measurements with reference measurements made in air, which has a relatively low, for practical purposes almost zero, conductivity:

$$\frac{ⅆ B}{ⅆ t} {\vert}_{formation} ≅ \frac{ⅆ B}{ⅆ t} {\vert}_{mandrel + formation} {°}^{- 1} \frac{ⅆ B}{ⅆ t} {\vert}_{mandrel + air} \qquad ( 2 )$$

There are many deconvolution methods known in the art, in the time domain or in the frequency domain. For the purpose of the example, frequency domain deconvolution will be explained now.

A convolution of two signals in the time domain corresponds to a multiplication of these signals in the frequency domain. Similarly, deconvolution in time-domain corresponds to division of the signals in the frequency domain.

If the signals are originally obtained in the time domain, such as might be the case in transient electromagnetic responses, the signals may first have to be transformed from time domain to frequency domain.

Various ways are known to transform the signal from time domain to frequency domain, including Fast Fourier Transformation (FFT), Hankel transformation, fast Hankel transformation, and inverse transformation.

Fast Hankel transformation is based on logarithmic sampling of the signals, and it is therefore particularly suited for signals of which the essential characteristics can be captured by equidistant logarithmic sampling which is typically the case for electromagnetic Green's functions.

Inverse transformation involves an iterative process wherein a trial signal is transformed from frequency domain to time domain, and compared to the actual signal that is to be transformed from the time domain to the frequency domain. The initial trial signal is then adjusted, the inverse transformation again calculated, and compared to the measured signal. This process is repeated until differences between the measured signal and the inversely transformed trial signal reach a minimum.

Another method of deconvolution is known as iterative deconvolution. Iterative deconvolution is preferred for embodiments of an electromagnetic measurement system which will measure transient response of earth formations. Iterative deconvolution may be used in such embodiments because the measurements represent a time-limited set of data rather than a substantially continuous measurement set, as in so-called frequency domain electromagnetic induction measurements. The deconvolution output is also time limited. Under the condition that the input data and output data are time limited, deconvolution may be implemented by solving a system of linear equations. Example iterative deconvolution methods are described in, Ioup, G. E. and Ioup, J. W., Iterative Deconvolution, Geophysics 48, pp. 1287-1290, Society of Exploration Geophysicists (1983).

Still another type of deconvolution that may be used in various embodiments of the invention is called parameterized deconvolution. This type of deconvolution is also particularly appropriate for transient EM measurements because the response of a transient EM instrument can be described by a series of exponential decay functions of the form:

$$h ( t ) = {\sum }_{k} {a}_{k} {ⅇ}^{- {b}_{k} l} \qquad ( 3 )$$

wherein a and b are parameters related to the system response and the characteristics of the earth formations surrounding the well logging instrument. Parameterized deconvolution is described, for example, in Hanstein, T., Iterative und parametrisierte Deconvolution fuer LOTEM Daten, 14. Kolloquium Elektromagnetische Tiefenforschung, pp. 163-172 (1992), and in Stolz, E. and Macnae, J., Evaluation of EM waveforms bit singular value decompositions of exponential basis functions, Geophysics 63, 1, pp. 64-74, Society of Exploration Geophysicists (1998).

Still another type of deconvolution that may be used in embodiments of the invention is called inversion deconvolution. An example of inversion deconvolution includes generating an initial model of earth formations, and calculating a trial response that a system without the conductive mandrel would provide, for instance based on an analytical point dipole tool geometry. The trial response is then convolved with the reference signal to obtain a calculated response. The actually obtained response of the instrument, with the conductive mandrel, is then compared to the calculated response. The initial model is then adjusted, the response again calculated, and compared to the measured response. This process is repeated until differences between the measured response and the calculated response reach a minimum. This process is well known in the art as “inversion”.

A possible advantage of using inversion deconvolution is that convolution is easier to perform mathematically and is more stable mathematically.

Inversion deconvolution may be a particularly useful method of deconvolution in cases where the earth formation is formed of a layered structure comprising layers having varying conductivity.

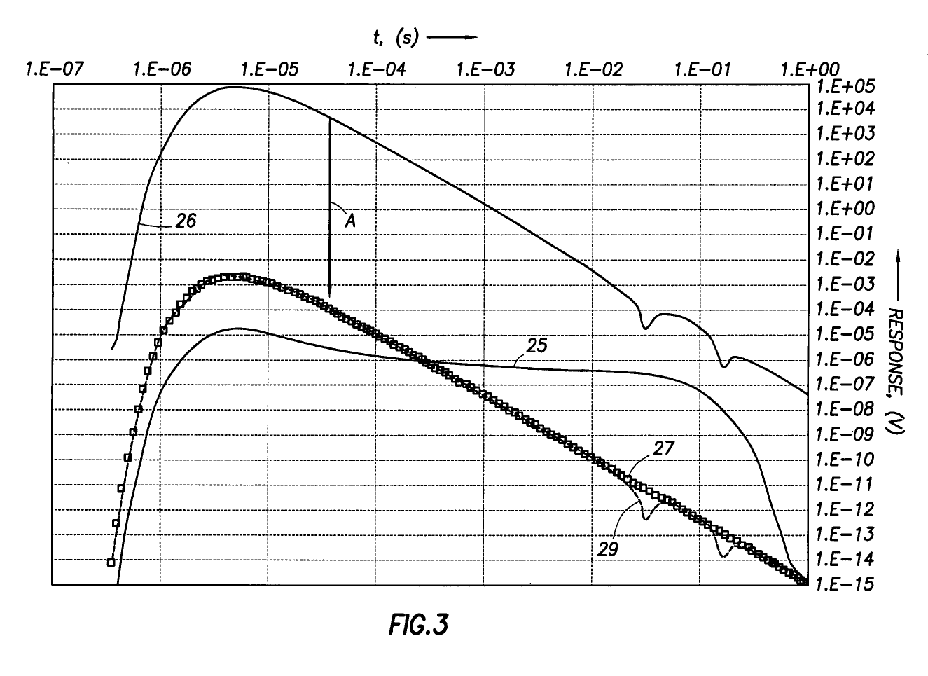

To demonstrate that the proposed deconvolution is able to remove the contribution from the mandrel to the signal, FIG. 3 shows an example. Parameters are listed in Table 2.

TABLE 2
legend to FIG. 3

| | | D | | Conductivity |
|---|---|---|---|---|
| | D coils | mandrel | | whole-space |
| lines | (mm) | (mm) | L (m) | (S/m) |
| 25-29 | 249 | 239 | 2 | 10 |

Curve 25 in FIG. 3 represents a simulated measurement of the response signal in a similar tool in a whole-space having a conductivity of 10 S/m, and curve 26 represents the same data after the reference signal measurable in air has been deconvolved from it. The dotted curve 27 represents a signal that would correspond to an analytical point dipole antennae in the whole-space with conductivity of 10 S/m without the mandrel contribution.

As can be seen, the deconvolved signal 26 is indeed remarkably similar in shape to the signal 27 corresponding to the signal that might be expected for point dipoles embedded in a whole-space environment. In the time range from approximately 3×10⁻⁷ s to 9×10⁻³ s, curves 26 and 27 almost differ only by a deconvolution scaling factor A of approximately μ₀×0.020 in this case. Curve 29 corresponds to curve 26 to which the appropriate scaling factor A has been applied.

It has been found that the deconvolution scaling factor depends mainly on the spacing L between the transmitter and receiver coils. It may also depend on other parameters such as the coil and mandrel diameters, but the deconvolution scaling factor is independent of the conductivity of the embedding formation.

FIG. 4 shows the dependency of the deconvolution scaling factor A with spacing L for the same diameter tool as used for FIG. 3. For each data point, the deconvolution scaling factor has been determined in whole-spaces having conductivities ranging from 0.1 to 100 S/m. It has been found that for co-axial tools around a metal mandrel the dependence of the deconvolution scaling factor on the spacing L can be numerically verified to behave as a power law:
A(L)≅0.1271·μ₀·L^{-2.68} (4)
as can be seen from the drawn trend line in FIG. 4.

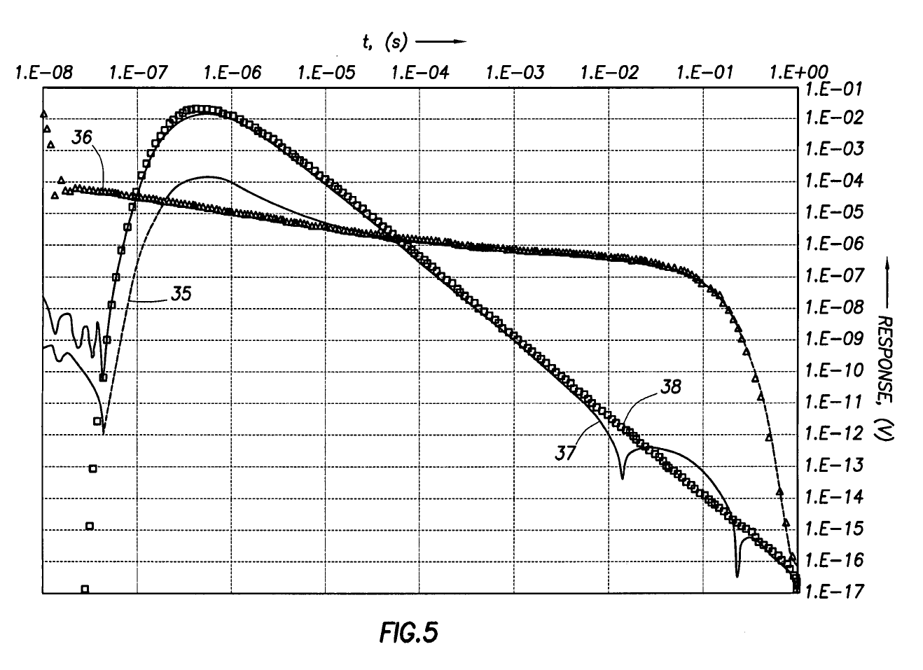

FIG. 5 demonstrates once more that applying this deconvolution scaling factor A, after deconvolving the reference signal from the raw signal, the result is remarkably similar to the point dipole signal in a whole-space. FIG. 5 (parameters listed in Table 3) shows a raw response signal curve 35 that can be measured using a coaxial tool on a mandrel surrounded by a formation, a reference signal curve 36 that can be measured using the same tool surrounded by air, a deconvolved signal curve 37 to which the deconvoluting scaling factor has been applied, and a theoretical signal curve 38 corresponding to analytical point dipoles surrounded by a whole-space having the conductivity of the formation.

TABLE 3
legend to FIG. 5

| | | D | | Conductivity |
|---|---|---|---|---|
| | D coils | mandrel | | whole-space |
| lines | (mm) | (mm) | L (m) | (S/m) |
| 35, 37, 38 | 249 | 239 | 2 | 1 |
| 36 | | | | 10⁻⁵ |

From the quality of the match of curves 37 and 38 it can be seen that the proposed deconvolution method allows for filtering out the mandrel's contribution from the raw response signal to a very large extent, except perhaps for times around 10^{-1.5} s. It should be noted that in this part, the raw response signal was almost fully determined by the mandrel contribution so that the curves 35 and 36 were extremely close together. Due to this fact, some zero-transitions could occur, which may give rise to numerical arteficts.

For the further examples in the specification below, an appropriate deconvolution scaling factor in accordance with the equation above will implicitly be applied unless explicitly stated to the contrary.

In the above-illustrated embodiments, the reference signal was determined in air as a test environment. While this is in theory easily achieved, by simply suspending the tool in the air, in a practical situation this may have drawbacks. For instance, it could involve lifting a substantial part of a drill sting tens of meters into the air away from any conductive objects including earth or metal, which is inherent to the fact that the logging system is intended to be sensitive to conductivity anomalies as far as maybe 50 meters—or even more—to the transmitter/receiver antennae whereas the reference signal is intended to represent the signal arising from the conductive mandrel only.

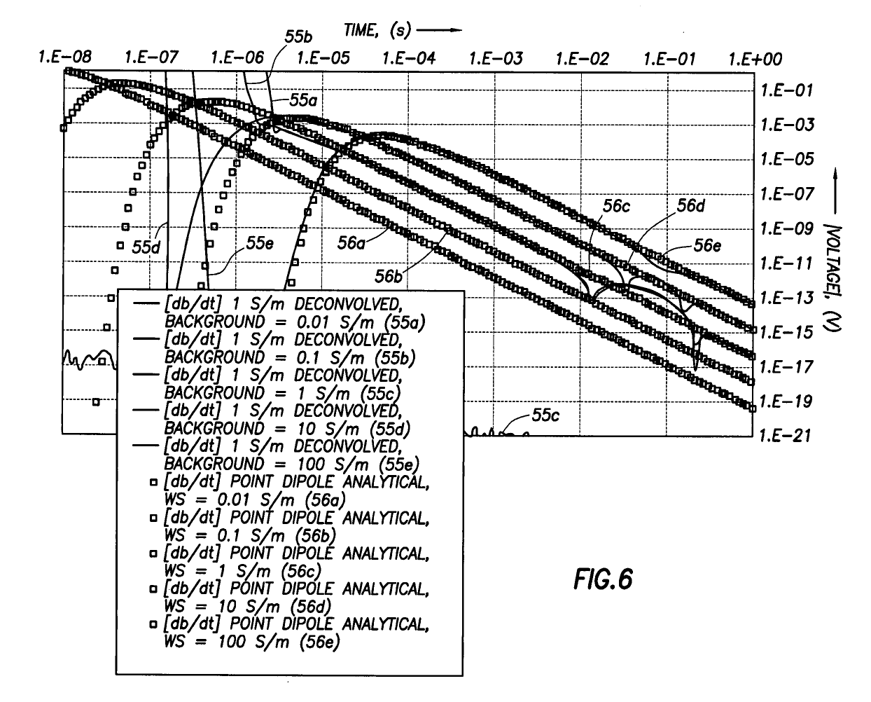

From this point of view, it would be advantageous to obtain the reference signal in a test environment that has a higher conductivity than that of air. This has been investigated, and FIG. 6 (as explained below) demonstrates that it works in test environments other than air, of which the conductivity is lower than that of the region in the earth formation of which the electromagnetic property of interest is to be determined.

FIG. 6 plots deconvolved response signals 55a to 55e (continuous lines) that can be obtained using a tool comprising coaxial transmitter and receiver coils wrapped around a metal mandrel, and respectively lowered in various earth formations with conductivities ranging from 0.01 S/m to 100 S/m in increments of factors of 10(see Table 4).

TABLE 4
legend to FIG. 6

| | | D | | Conductivity |
|---|---|---|---|---|
| | D coils | mandrel | | whole-space |
| lines | (mm) | (mm) | L (m) | (S/m) |
| 55a, 56a | 249 | 239 | 2 | 0.01 |
| 55b, 56b | 249 | 239 | 2 | 0.1 |
| 55c, 56c | 249 | 239 | 2 | 1 |
| 55d, 56d | 249 | 239 | 2 | 10 |
| 55e, 56e | 249 | 239 | 2 | 100 |

The response signals reflect dB/dt, wherein B represents magnetic induction. The reference signal that was used to deconvolve the raw response signal was obtained using the same tool configuration surrounded by a test environment having a conductivity 1 S/m. In addition, the analytically computed point-dipole whole-space solutions 56a to 56e (dotted curves) are shown for each of the various earth formations.
From the figure it is concluded that the deconvolution procedure is successful as long as the test environment has a lower conductivity than the region in the earth formation of interest. Apparently, the conductivity contrast between ‘formation-of-interest’ and ‘reference test environment’ need not be extremely large. It can be lower than the contrast between ‘formation-of-interest’ and air, for instance lower than 10,000 or lower than 1,000.

Preferably, the test environment has a conductivity that is at least 5 times lower than that of the region in the earth formation, more preferably at least 9 or 10 times lower.

Thus, for the reference-procedure alluded to in the previous subsection it should not be necessary to lift the whole drill string up into the air but it would suffice to measure the signal in a sufficiently thick layer that is more resistive than our target formation, or preferably at least 5 times more resistive, more preferably at least 9 or 10 times more resistive.

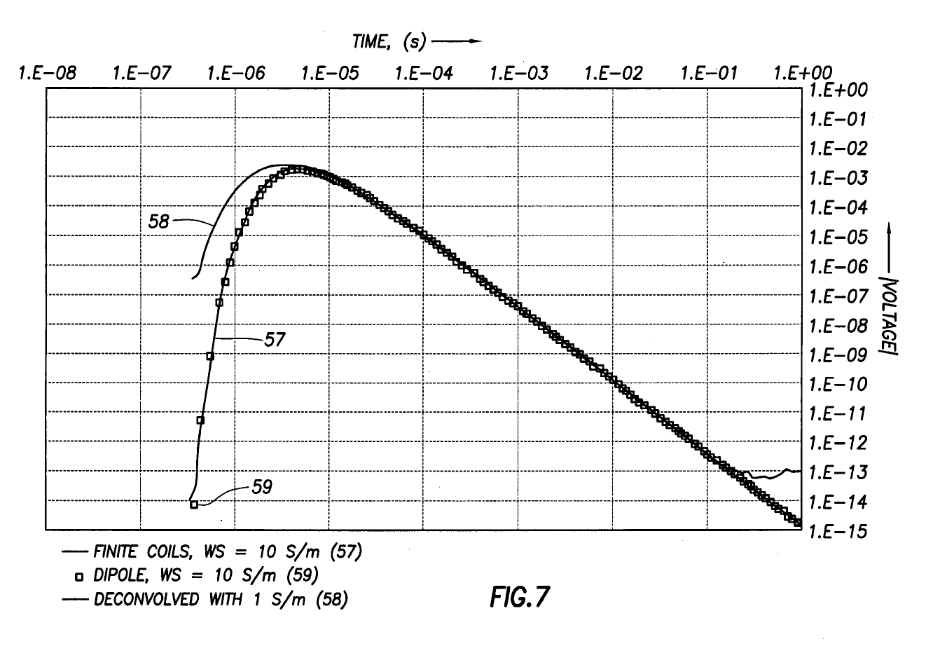

A possible influence of the contrast in conductivity between the mandrel, or more generally the conductive support structure, and the earth formation on the proposed deconvolution method has also been investigated. This is explained with reference to FIG. 7, wherein a less conductive mandrel is employed having a conductivity of 10 S/m instead of 1×10⁷ S/m as was the case in the previous examples. The conductivity of the earth formation was also 10 S/m. Response signals, both as measurable (curve 57) and deconvolved using a reference signal obtained in a test environment having a conductivity of 1 S/m (curve 58), are plotted. For reference, the dotted curve 59 corresponds to the analytical point dipole solution in a whole-space having a conductivity of 10 S/m. The parameters are summarized in Table 5.

TABLE 5
legend to FIG. 7

| | | D | | Conductivity |
|---|---|---|---|---|
| | D coils | mandrel | | whole-space |
| lines | (mm) | (mm) | L (m) | (S/m) |
| 57-59 | 249 | 239 | 2 | 10 |

As expected, since the mandrel in this example has the same conductivity as the earth formation, the raw response signal (curve 57) measureable is near-identical to the analytical point dipole solution (curve 59). Given the extreme values used in this example, the deconvolved signal (curve 58) is quite close to the raw response of curve 57 indicating that the conductivity contrast between the mandrel and the earth formation is not of critical influence on the proposed method of the invention.

One of the anticipated uses of the tool and the methods described above is in mapping underground formations that are not homogeneous whole-spaces but may contain an anomaly. For instance, it may be desirable to extract information about direction to and/or distance from the tool to a formation boundary.

FIG. 8 shows an example wherein a coaxial tool 2 with transmitter-receiver spacing L=1 m is placed in, for example, a vertical well 4 approaching an adjacent bed that defines the resistivity anomaly. The tool 2 includes both a transmitter coil T and a receiver coil R, which are wound around a common tool axis and are oriented in the tool axis direction. The symbols σ₁ and σ₂ may represent the conductivities of two formation layers

There are three parameters that may be determined in the two-layer model. These are:

(1) the conductivity σ₁ or resistivity of the local layer where the tool is currently placed;

(2) the conductivity or resistivity σ₂ of the adjacent bed; and

(3) the distance d of the tool to the layer boundary.

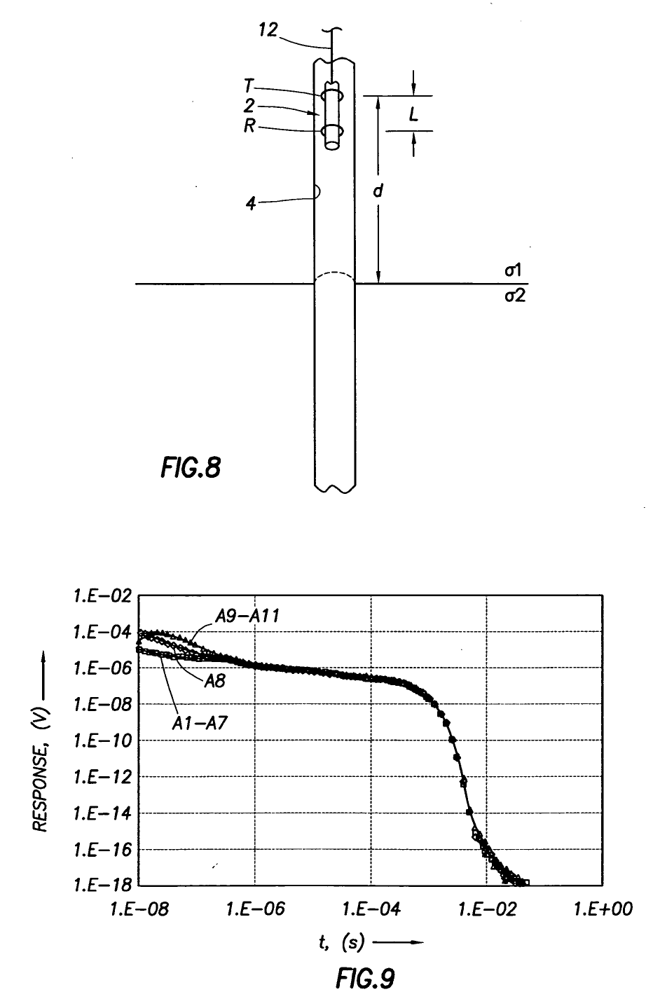

FIG. 9 shows simulated signals that would be measurable with this tool as it approaches bed 2 and is moved from one bed into the other. Curves A1 to A11 respectively correspond to d=100 m, 50 m, 20 m, 10 m, 5 m, 2 m, 1 m, 0 m, −1 m, −10 m; −100 m. Parameters are listed in Table 6.

TABLE 6
legend to FIGS. 9-11

| | | | Conductivity | Conductivity |
|---|---|---|---|---|
| | L | | halfspace 1 | halfspace 2 |
| lines | (m) | d (m) | (S/m) | (S/m) |
| A1, B1, C1 | 1 | 100 | σ₁ = 0.01 | σ₂ = 1 |
| A2, B2, C2 | 1 | 50 | σ₁ = 0.01 | σ₂ = 1 |
| A3, B3, C3 | 1 | 20 | σ₁ = 0.01 | σ₂ = 1 |
| A4, B4, C4 | 1 | 10 | σ₁ = 0.01 | σ₂ = 1 |
| A5, B5, C5 | 1 | 5 | σ₁ = 0.01 | σ₂ = 1 |
| A6, B6 | 1 | 2 | σ₁ = 0.01 | σ₂ = 1 |
| A7, B7 | 1 | 1 | σ₁ = 0.01 | σ₂ = 1 |
| A8, B8, C8 | 1 | 0 | σ₁ = 0.01 | σ₂ = 1 |
| A9, B9 | 1 | −1 | σ₁ = 0.01 | σ₂ = 1 |
| A10, B10, C10 | 1 | −10 | σ₁ = 0.01 | σ₂ = 1 |
| A11, C11 | 1 | −100 | σ₁ = 0.01 | σ₂ = 1 |

Curves A1 to A7 (corresponding to tool surrounded by bed 1) almost overlap with each other, and so do curves A9 to A11 (corresponding to tool in bed 2). Curve A8 (tool on the interface) is in between.

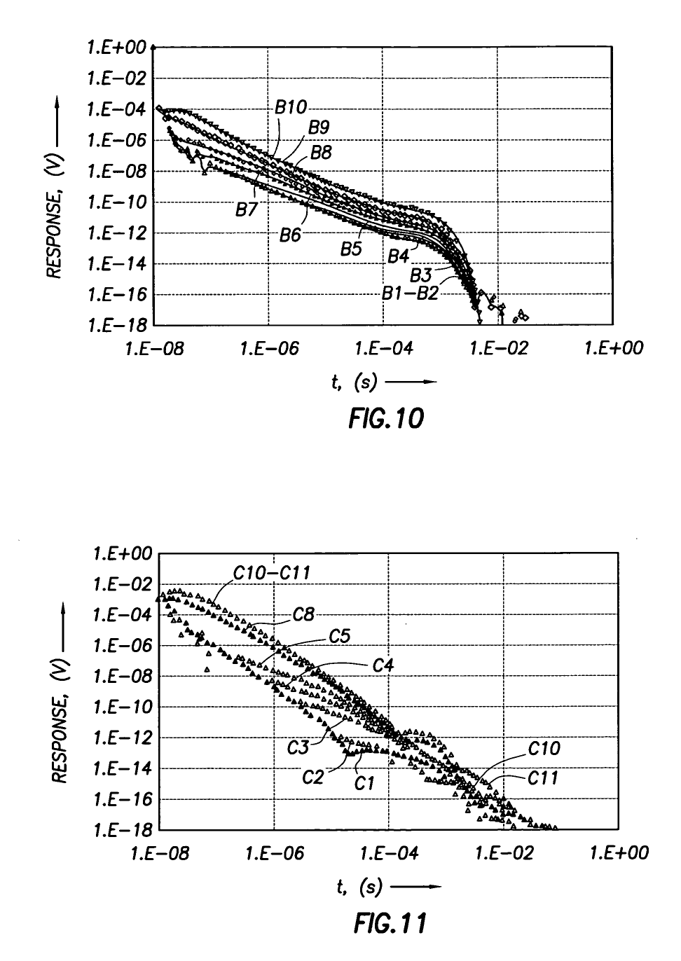

FIG. 10 shows the same curves as in FIG. 9 but now adjusted with a reference signal, determined with the tool in air as the test environment, subtracted from it. The individual curves B1 to B10 can now be distinguished, so it is anticipated that information such as distance between tool and bed boundary can be extracted from these adjusted curves.

FIG. 11 shows the curves C1 to C5, C8, and C10 to C11 corresponding to A1 to A5, A8, and A10 to A11 but this time adjusted by deconvolving the reference signal from the signal. Reference is made to Table 6.

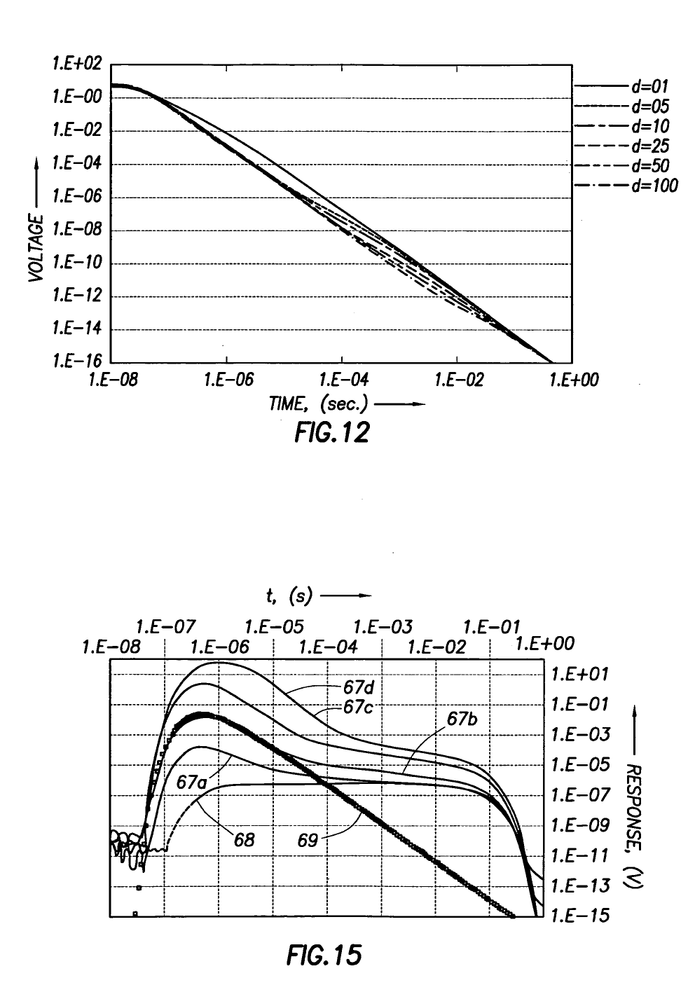

Results of a similar calculation, but for a tool without conductive support structure, have been published earlier in Table 27 of U.S. patent application publication 2005/0092487 which is reproduced here as FIG. 12. In that calculation, d=1, 5, 10, 25, and 50 m were taken, as given in the legend. Again, the conductivities of the respective beds were σ₁=0.1 and σ₂=1.

The qualitative and quantitative behaviour of the deconvolved curves in present FIG. 11 is strikingly similar to the curves of FIG. 12 demonstrating that the adjustment by deconvolution does well at removing the mandrel contribution from the signal. It is noted that information on the distance to the bed boundary is readily reflected in the time at which the signal transits from the trajectory of the A1 to the trajectory of the A11 curve.

This demonstrates that the presently proposed adjustment of transient EM signals can be used to extract information from the transient EM signals that would otherwise be nearly impossible. With the proposed methodology, transient EM measurements can more easily be employed as a look-ahead resistivity logging method whereby the transient response of the tool in for instance a two-layer earth model may be examined.

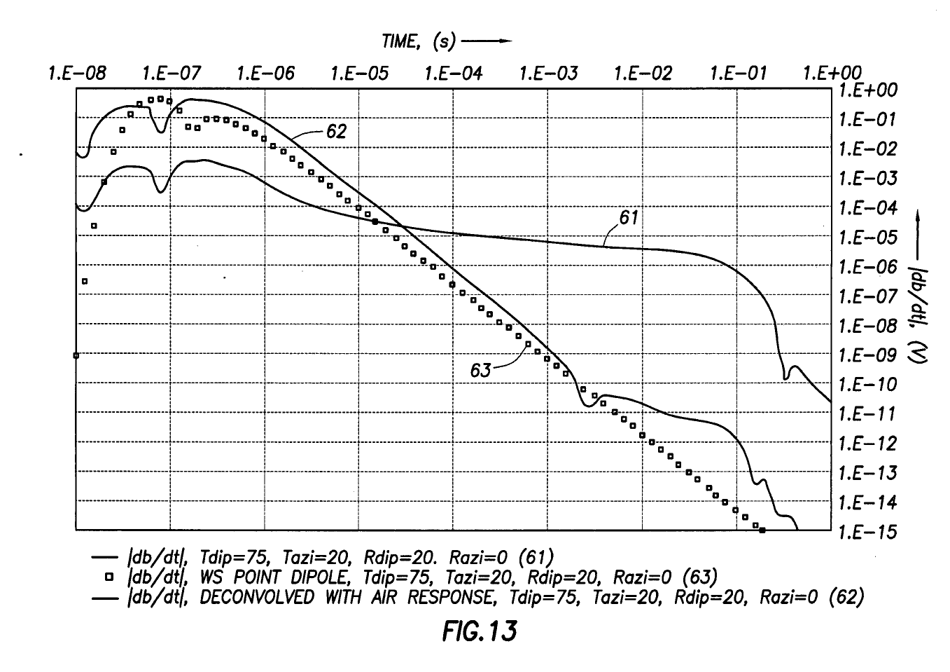

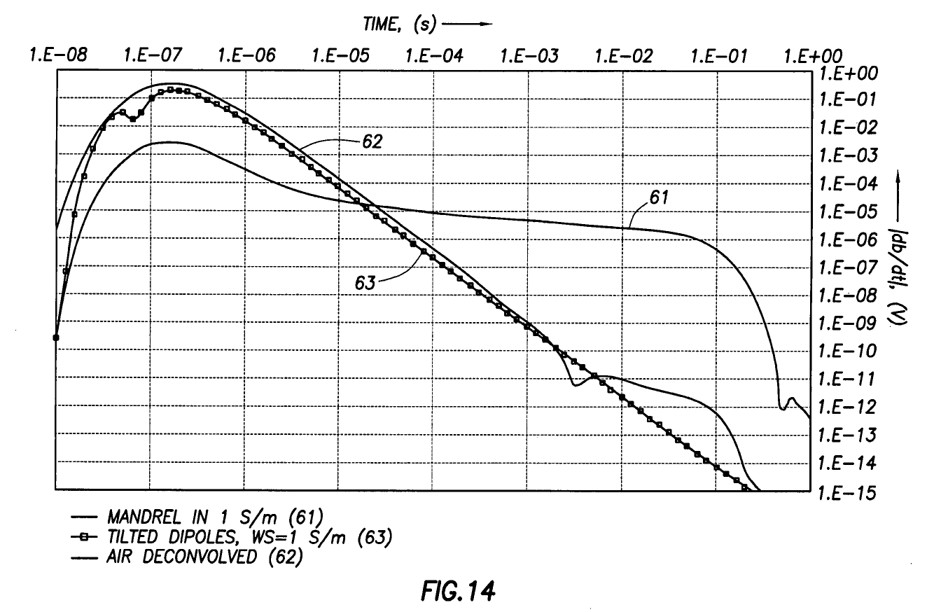

The deconvolution method so far been demonstrated using tools with co-axially arranged coil antennas, but it also works with other antenna arrangements. This is illustrated with reference to FIGS. 13 and 14 (see also Table 7).

TABLE 7
legend to FIGS. 13 and 14

| | | D | | Conductivity |
|---|---|---|---|---|
| | D coils | mandrel | | whole-space |
| lines | (mm) | (mm) | L (m) | (S/m) |
| 61-63 | 249 | 239 | 1 | 1 |

In these Figures, responses are shown for tool systems comprising an infinite steel mandrel on a tool axis, around which a non-coaxial transmitter and receiver have been wrapped. The transmitter and receiver coils are elliptical. The quoted radius is that of their projection on a plane perpendicular to the tool-axis. FIG. 13 plots results for a tool wherein the transmitter coil is arranged under a dip angle of 75 degrees relative to the tool- and mandrel axis, and the receiver coil is arranged under a dip angle of 20 degrees. The respective planes in which the transmitter and receiver coils are coiled are rotated about the tool axis relative to each other, resulting in that there is a relative azimuthal angle of 20 degrees between receiver and transmitter coils. Plotted are the raw response signal curve 61 as can be measured with the described tool in an earth formation having a conductivity of 1 S/m, a deconvolved curve 62 using a reference curve as obtainable in air, and an analytical point dipole response curve 63 in a corresponding whole-space.

FIG. 14 plots equivalent results for a transmitter that has a dip relative to the mandrel axis of 10 degrees, whereas the receiver has a dip of 60 degrees; the relative azimuth between transmitter and receiver is 20 degrees.

The FIGS. 13 and 14 show that the deconvolution method of the invention works also for non-coaxial tools. The deconvolution scaling factor has been employed as defined above, i.e. as determined for a co-axial tool having zero dip and azimutal angles, and it can be seen that it needs a slight modification due to the dip angles. More accurate deconvolution scaling factors can be determined in an analogous way as described above for co-axial tools. Moreover, a zero-crossing is observed in the point-dipole curve near 10⁻⁷ s, which is possibly due to the relative dip and azimuth of the point-dipoles. The absence of this zero-crossing in the other curves was shown to be due to the finite size of the coils.

Magnetic Shielding

Another way of reducing the conductive support structure's contribution to the raw response signal is to lower its contribution physically during the measurement.

One way of achieving this is by replacing the conductive support structure fully or in part by a non conductive or at least less conductive alternative.

Another way of achieving this, or at least help in achieving this, is by first providing the conductive support structure with a magnetic shield layer. This is based on an insight that a magnetic shield can reduce or prevent the penetration of the magnetic field in the metal of the support structure. In a transient measurement, whereby the current passed through the transmitter antenna is suddenly changed, the induction of eddy currents in the conductive support structure will be reduced. Consequently, the contribution of the support structure to the raw response signal would be reduced.

One way of implementing this is to apply a coating comprising a resistive high-μ layer having resistivity and magnetic permeability μ both higher than those of the conductive support structure. A value of μ/μ₀=1000, for example, should be achievable in practice.

FIG. 15 depicts raw response signal curves 67a to d that can be made using a tool in a whole-space formation, comprising coaxial transmitter and receiver coils wrapped around a conductive support structure, in the form of a (solid) metal mandrel encapsulated by a relatively thin resistive high-μ layer of relative magnetic permeabilities μ/μ₀ of, respectively, 1, 10, 100, and 1000, surrounded by a uniform whole-space having a conductivity of 1 S/m. Table 8 provides the legend.

TABLE 8
legend to FIGS. 13 and 14

| | | D | | | Conductivity |
|---|---|---|---|---|---|
| | D coils | mandrel | | | whole-space |
| lines | (mm) | (mm) | μ/μ₀ | L (m) | (S/m) |
| 67a | 249 | 239 | 1 | 2 | 1 |
| 67b | 249 | 239 | 10 | 2 | 1 |
| 67c | 249 | 239 | 100 | 2 | 1 |
| 67d | 249 | 239 | 1000 | 2 | 1 |
| 68 | 249 | 239 | steel | 2 | 1 |
| 69 | 249 | 239 | — | 2 | 1 |

The mandrel has a diameter of approximately 24 cm, the layer thickness of the resistive high-μ layer is approximately 0.5 cm. The responses have been scaled to account for the coil-area but changes in the effective moment due to the presence of high-μ material have not been taken into account.

The figure also includes curve 68 for the case where the ‘shielding layer’ consists of the same material as the mandrel, i.e. a nonmagnetic metal, and for reference a curve 69 corresponding to the analytical point dipole solution in the whole-space is also shown.

As can be seen in FIG. 15, the presence of a magnetic insulator with sufficiently high value of μ changes primarily the early-time behavior of the curves causing the curve 67d, for μ/μ₀=1000, to become fairly similar in shape to the analytical whole-space point-dipole response 69, at least up to ˜10⁻⁴ s. After that time the plateau behaviour, indicative of the mandrel contribution, becomes apparent.

Without attempting to provide definitive explanations it is interesting to note that for times on the order of 1 sec the curves seem to fall back to whole-space-like responses, albeit at different levels for different values of μ. The latter could be understood since the presence of the magnetic material will tend to increase the effective coil moments. In fact, matching this late-time behaviour to the analytical unit moment point dipole result should provide a means to establish the moment-increasing effect of the magnetic material. It is also interesting to observe that the maxima of the curves roughly increase in proportionality with the square of μ/μ₀. This may be explained by noting that both the effective moment of the receiver and the transmitter may be expected to increase when magnetic material is added.

It turns out that the thickness of the insulating magnetic layer is relatively unimportant. Additional calculations (not shown) reveal that even an insulating magnetic layer as thin as 2.5 mm has the desired effect.

Subtraction

A computationally simpler way to adjust the raw response signal is by subtracting the reference signal from it.

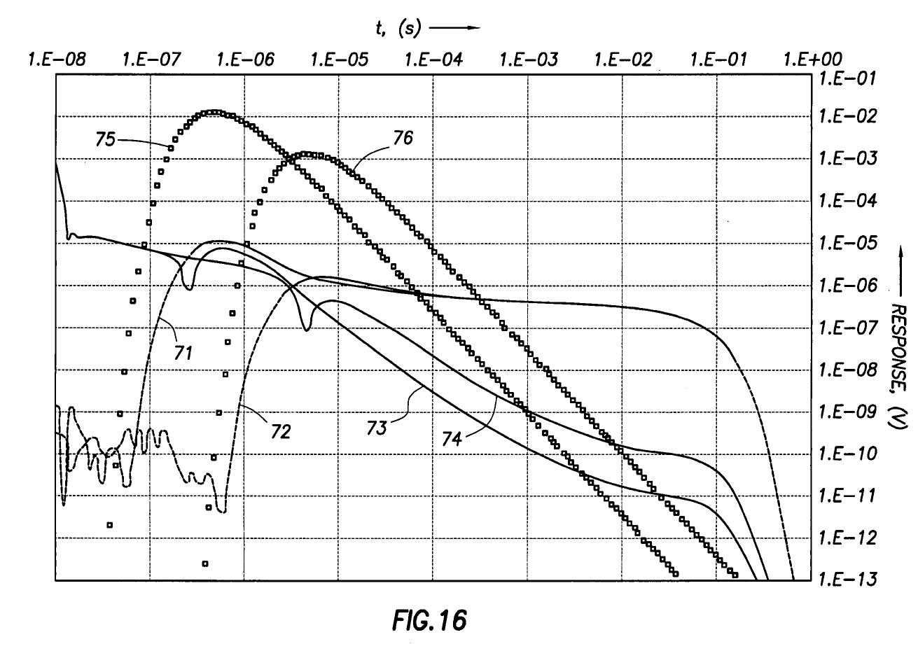

Referring, again, to FIG. 2, this would mean subtracting curve 9 from curve 8. Typical results can be seen in FIG. 16, where the dash-dotted curves 71 and 72 represent the raw response signal curves obtained from ‘raw’ measurements of a finite, coaxial coil system wrapped around an (infinite) metal cylinder of slightly smaller diameter embedded in whole-spaces of 1 and 10 S/m.

TABLE 9
legend to FIG. 16

| | | D | | Conductivity |
|---|---|---|---|---|
| | D coils | mandrel | | whole-space |
| lines | (mm) | (mm) | L (m) | (S/m) |
| 71, 73, 75 | 249 | 246 | 2 | 1 |
| 72, 74, 76 | 249 | 246 | 2 | 10 |

When the measurement of this system made in near-zero conductivity environment such as air (curve not shown) is subtracted from the raw curves, and plotted on a logarithmic scale, the solid curves 73 and 74, depicted in the figure are arrived at. The ‘bumps’ most prominently present around 10-6.5 sec for curve 73 and around 10^{-5.4} sec for curve 74 can be attributed to the fact that there is a gap between the coil and the surface of the steel.

For reference, the dotted curves 75 and 76 in this figure depict the analytical whole-space response curves of two point-dipoles surrounded by material having conductivities of 1 and 10 S/m, respectively.

Plotted on logarithmic scales, there is more distinction between the curves 73 and 74 (1 and 10 S/m background) than there was between their raw equivalents in curves 71 and 72. This holds specifically for later times; for early times (t<10^{-5.5} sec), on the other hand, things do not seem to improve as much.

It is concluded that subtraction in accordance with certain embodiments of the invention is effective in more clearly revealing the formation contribution to the response, in particular when plotted on a logarithmic scale. However, it appears to yield a less good match with the analytical point dipole solutions (depicted in curves 75 and 76) than the proposed deconvolution method.

Adjustment in Combination with Magnetic Shielding

However, a remarkable improvement is obtained by combining the proposed subtraction with the provision of the magnetic shielding layer as discussed above.

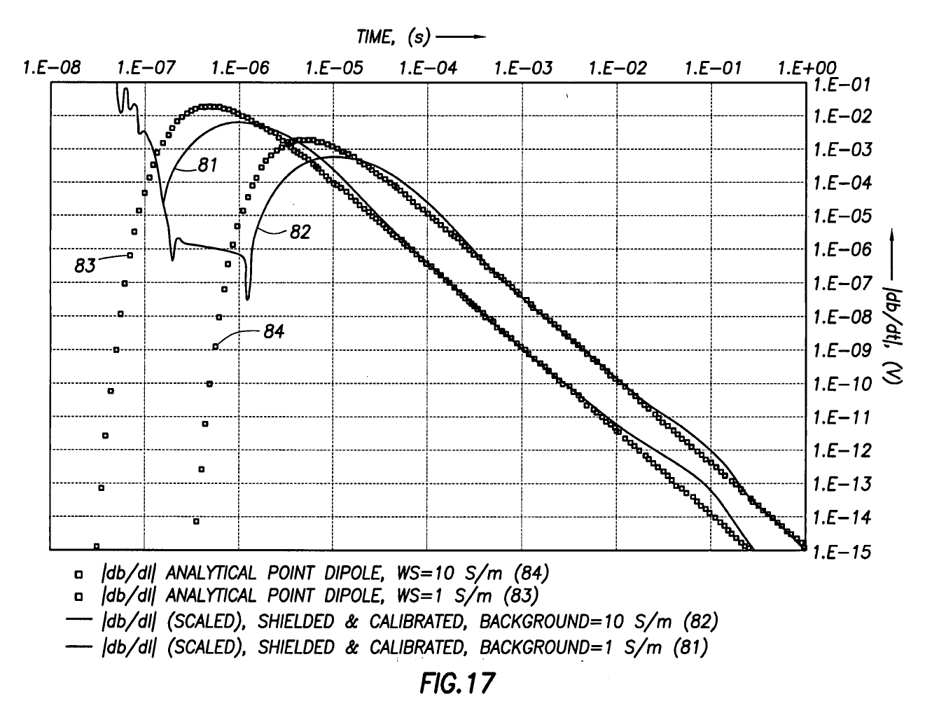

FIG. 17 shows adjusted response signal curves 81 and 82 obtained using a tool having a mandrel covered by a layer of resistive material with μ/μ₀=1000 in two earth formations respectively having 1 S/m and 10 S/m conductivity, as compared with analytical point dipole solutions 83 and 84 in such earth formations.

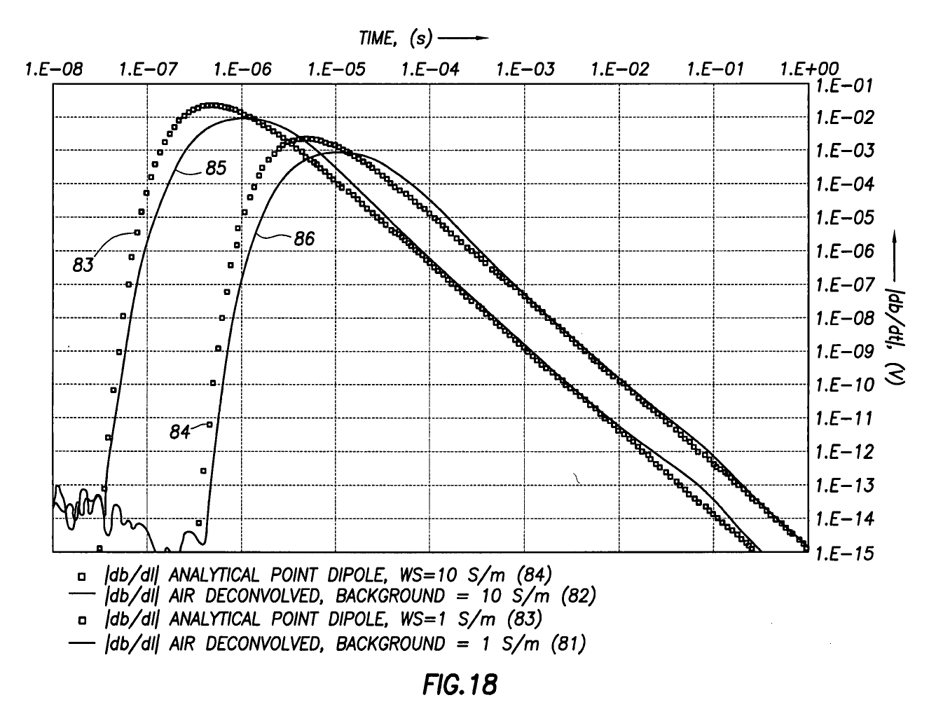

TABLE 10
legend to FIGS. 17 and 18

| | | D | | Conductivity |
|---|---|---|---|---|
| | D coils | mandrel | | whole-space |
| lines | (mm) | (mm) | L (m) | (S/m) |
| 81, 83, 85 | 244 | 239 | 2 | 1 |
| 82, 84, 86 | 244 | 239 | 2 | 10 |

An empirically determined scaling factor of approximately 10⁻⁴ has been applied as well. The thickness of the magnetic shielding layer was 0.25 cm.

A good match is achieved between curves 81 and 83, and between curves 82 and 84, which is believed to be due to a combination of benefits. The proposed adjustment by subtraction, as has been found above, provides its best results at relatively long times after the sudden change in the current passed through the transmitter antenna, while the proposed magnetic shielding provides its best results at relatively short times.

Magnetic shielding can also be combined with the above proposed deconvolution method, as will be illustrated in FIG. 18. In FIG. 18 the same raw response and reference signals have been used from the same tool as was the case for FIG. 17, but this time the adjustment of the raw response signal was done using deconvolution. The results are shown in curve 85 for the earth formation having conductivity of 1 S/m and in curve 86 for the earth formation having conductivity of 10 S/m.

The match of the subtraction-adjusted signals of FIG. 17 is almost as good as for the deconvolution-adjusted signals, which was not the case for the unshielded tool (compare, for instance, FIGS. 5 and 16).

Notwithstanding the fact that the match with the analytical point dipole solutions is somewhat less good in FIG. 18 than in FIG. 5 (similar tool but with no magnetic shielding), magnetic shielding has the advantage that the zero-transitions in the signal at the longer times have been suppressed, making the data easier to interpret for long times.

In view of the computational advantages of the subtraction method over the deconvolution method, the subtraction method may be the most preferable of the two, particularly when applied in combination with magnetic shielding of the conductive support structure.

Geosteering Applications

The method of determining the electromagnetic response from a region in an earth formation may for example be performed as part of a method of drilling a borehole, wherein the borehole is drilled using a drill string that comprises the electromagnetic measurement tool.

As explained above, the electromagnetic response may be utilized in determining an electromagnetic induction property of an earth formation. This allows for measuring the electromagnetic induction property of the region in the earth formation while drilling progresses. This information may then be utilized in taking decisions on steering of the path during further drilling.

The electromagnetic response, or the derived induction properties of the earth formation, may be indicative of the presence of a region that one wants to drill to, such as for instance a hydrocarbon fluid containing region. It may also be indicative of a region that one wants to steer away from to avoid drilling through, such as for instance an unfavourable fault in the earth formation.

The electromagnetic response may reveal a water-oil interface on the basis of regional differences in conductivity. Or the electromagnetic response may reveal the presence of an anomaly in the earth formation including, for instance, a salt dome or a hydrocarbon containing reservoir.

In all these cases, geosteering may be accomplished by determining the electromagnetic response of the earth while drilling, deriving a geosteering cue from the response, and steering the drill bit in accordance with the geosteering cue. Deriving the geosteering cue from the response may comprise determining an electromagnetic property of the earth formation and/or of a region in the earth formation.

Such a geosteering cue may follow from the location of an electromagnetic anomaly relative to the electromagnetic measurement tool which follows from the electromagnetic response. Since embodiments of the present invention provide a response that better reflects the properties of the formation and a higher sensitivity, it is envisaged that anomalies can be detected at larger distances, say up to 100 m, with better accuracy than was possible before.

In order to ultimately produce the mineral hydrocarbon fluid from the earth formation, a wellbore may be drilled using a drill string with a method of drilling a borehole in which at least a part of the drilling comprises:

lowering the drill string into the borehole that is being drilled;

passing a current through the transmitter antenna resulting in an induction signal in the receiver antenna;

measuring a raw response signal comprising the induction signal;

adjusting the raw response signal using a reference signal obtained by measuring the response signal of the tool in a test environment having a resistivity that is higher than that of the region in the earth formation;

utilizing the adjusted signal to determine an electromagnetic induction property of the earth formation; and

steering the drill string during continued drilling of the hole in response to the determined electromagnetic property of the earth formation.

The drilling method may be continued until a reservoir containing the mineral hydrocarbon fluid is detected and reached.

Once the wellbore extends into the reservoir, the wellbore may be completed in any conventional way and the mineral hydrocarbon fluid may be produced via the wellbore.

This may all be implemented using the system as schematically depicted in FIG. 1B. The steering may employ steering system 19.

The geosteering cue may comprise information reflecting distance between the anomaly and the bit which may be calculated employing the optional distance calculation module 48 and/or information reflecting direction from the bit to the anomaly which may be calculated employing one or both of the optional direction and apparent direction calculation modules 44,46.

We claim:

1. A method of determining an electromagnetic response from a region in an earth formation, comprising:
lowering an electromagnetic measurement tool comprising a transmitter antenna, a receiver antenna, and an electrically conductive support structure, into a borehole in the earth formation;
energizing the transmitter antenna resulting in a receiver signal in the receiver antenna;
measuring a raw response signal comprising the receiver signal;
adjusting the raw response signal using a reference signal obtained by measuring the response signal of the tool in a test environment having a resistivity that is higher than that of the region in the earth formation.

2. The method of claim 1, wherein the receiver signal comprises contributions originating from the region in the earth formation and originating from the electrically conductive support structure, and wherein the reference signal is used to remove at least some of the contribution from the electrically conductive support structure from the raw response signal.

3. The method of claim 1, wherein the resistivity in the test environment is at least five time higher than that of the region in the earth formation.

4. The method of claim 1, wherein the resistivity in the test environment is lower than the resistivity in air.

5. The method of claim 1, wherein the test environment is formed by a second region in the earth formation outside the region from where the electromagnetic response is to be determined.

6. The method of claim 1, wherein measuring the raw response signal includes monitoring the receiver signal as a function of time following a change in energizing of the transmitter antenna.

7. The method of claim 6, wherein the change includes terminating the energizing of the transmitter antenna.

8. The method of claim 1, wherein the conductive support structure is provided with a magnetic shield layer comprising a material that has a magnetic permeability that is higher than that of the conductive support structure.

9. The method of claim 8, wherein the material comprised in the magnetic shield layer has a resistivity higher than that of the conductive support structure.

10. The method of claim 8, wherein the raw response signal is adjusted using the reference signal by deconvolving the reference signal from the raw response signal.

11. The method of claim 10, wherein after deconvolving the reference signal from the raw response signal, a scaling factor is applied to the adjusted response signal.

12. The method of claim 8, wherein the raw response signal is adjusted using the reference signal by subtracting the reference signal from the raw response signal.

13. The method of claim 1, wherein the raw response signal is adjusted using the reference signal by subtracting the reference signal from the raw response signal.

14. The method of claim 1, wherein the raw response signal is adjusted using the reference signal by deconvolving the reference signal from the raw response signal.

15. The method of claim 14, wherein after deconvolving the reference signal from the raw response signal, a scaling factor is applied to the adjusted response signal.

16. The method of claim 1, wherein energizing the transmitter antenna comprises passing a current through the transmitter antenna, and wherein the receiver signal is an induction signal.

17. A system for determining an electromagnetic response from a region in an earth formation, comprising:
an electromagnetic measurement tool that is lowerable in a borehole in the earth formation, the electromagnetic measurement tool comprising a transmitter for transmitting a signal, a receiver for receiving a receiver signal, and an electrically conductive support structure;
a data acquisition unit coupled to at least the receiver to collect a raw response signal comprising the receiver signal from the receiver;
a computing system coupled to the acquisition system to receive the raw response signal and programmed to adjust the raw response signal using a reference signal obtained by measuring the response signal of the tool in a test environment having a resistivity that is higher than that of the region in the earth formation.

18. A method of drilling a borehole in an earth formation, comprising drilling the borehole using a drill string whereby at least a part of the drilling comprises:
lowering the drill string into the borehole that is being drilled, the drill string comprising an electromagnetic measurement tool comprising a transmitter antenna, a receiver antenna, and an electrically conductive support structure;
energizing the transmitter antenna resulting in a receiver signal in the receiver antenna;
measuring a raw response signal comprising the receiver signal;
adjusting the raw response signal using a reference signal obtained by measuring the response signal of the tool in a test environment having a resistivity that is higher than that of the region in the earth formation.

19. The method of claim 18, further comprising:
utilizing the adjusted signal to determine an electromagnetic induction property of the earth formation; and
steering the drill string during continued drilling of the hole in response to the determined electromagnetic property of the earth formation.

20. The method of claim 18, wherein energizing the transmitter antenna comprises passing a current through the transmitter antenna, and wherein the receiver signal is an induction signal.

21. A method of producing a mineral hydrocarbon fluid from an earth formation, comprising
drilling a borehole in the earth formation until a reservoir is reached that contains the mineral hydrocarbon fluid; and
producing the hydrocarbon fluid from the reservoir; wherein borehole is drilled in accordance with a method wherein a drill string is lowered into the borehole that is being drilled, the drill string comprising an electromagnetic measurement tool comprising a transmitter antenna, a receiver antenna, and an electrically conductive support structure;
the transmitter antenna is energized resulting in an receiver signal in the receiver antenna;
a raw response signal comprising the receiver signal is measured; and
the raw response signal is adjusted using a reference signal obtained by measuring the response signal of the tool in a test environment having a resistivity that is higher than that of the region in the earth formation.
